(19) United States
(12) Patent Application Publication
(10) Pub. No.: US 2017/0277382 A1
(43) Pub. Date: Sep. 28, 2017

(54) PAGE SWITCHING METHOD AND DEVICE APPLIED TO ELECTRONIC EQUIPMENT

(71) Applicants: Le Holdings (Beijing) Co., Ltd., Beijing (CN); Lemobile Information Technology (Beijing) Co., Ltd, Beijing (CN)

(72) Inventor: Yuchen Guo, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/243,465

(22) Filed: Aug. 22, 2016

Related U.S. Application Data
(63) Continuation of application No. PCT/CN2016/088796, filed on Jul. 6, 2016.

(30) Foreign Application Priority Data
Mar. 24, 2016 (CN) 201610172924.9

(51) Int. Cl. G06F 3/0488; G06F 3/0484

(52) U.S. Cl. CPC G06F 3/0488; G06F 3/0484; G06F 2203/04808

(57) ABSTRACT

A page switching method applied to an electronic device and the electronic device includes: judging whether a current interactive graphic interface displayed by a display unit of the electronic device is a calendar interface or not; if the current interactive graphic interface is the calendar interface, then detecting whether an interface switching instruction is received or not in the calendar interface, wherein the interface switching instruction comprises a pinch-in reduction instruction or a pinch-out enlargement instruction, and a view comprises a year view and a month view; and switching the view displayed currently into another view according to the interface switching instruction.

### CROSS REFERENCE TO RELATED APPLICATIONS

This disclosure is a continuation of International Application No. PCT/CN2016/088796 filed on Jul. 6, 2016, which is based upon and claims priority to Chinese Patent Application No. 201610172924.9, filed on Mar. 24, 2016, titled “PAGE SWITCHING METHOD APPLIED TO ELECTRONIC DEVICE AND ELECTRONIC DEVICE”, and the entire contents of which are incorporated herein by reference.

### TECHNICAL FILED

This disclosure relates to the field of electronic technologies, and specifically relates to a page switching method applied to an electronic device and the electronic device.

### BACKGROUND

In the prior art, a calendar in a terminal generally has two types of view modes: a month view and a year view, where the month view shows time information of a month and the year view shows time information of a year.

At present, the switching between the two types of view modes can only be achieved by clicking a time view selection button of the year view/month view. This manner of switching is relatively monotonous and is less accurate.

An effective solution has not been proposed to solve the problem that the manner of switching between the year view and the month view is relatively monotonous and is less accurate in a related technology.

### SUMMARY

This disclosure discloses a page switching method applied to an electronic device and the electronic device to overcome the problem that the manner of switching between the year view and the month view is relatively monotonous and is less accurate in the prior art.

One objective of the embodiments of this disclosure is to provide a page switching method applied to an electronic device which includes a display unit, and the method includes: judging whether a current interactive graphic interface displayed by the display unit is a calendar interface or not; if the current interactive graphic interface is the calendar interface, detecting whether an interface switching instruction is received or not in the calendar interface, where the interface switching instruction includes a pinch-in reduction instruction or a pinch-out enlargement instruction, the calendar interface only displays one view during a non-switching period, and the views include a year view and a month view; and switching the view displayed currently in the calendar interface into another view according to the interface switching instruction.

Alternatively, switching the view displayed currently in the calendar interface into another view according to the interface switching instruction includes: in the case that the view displayed currently in the calendar interface is a month view, switching the month view into a year view when the pinch-in reduction instruction or the pinch-out enlargement instruction is received; or in the case that the view displayed currently in the calendar interface is a year view, switching the year view into a month view when the pinch-out enlargement instruction or the pinch-in reduction instruction is received.

Alternatively, switching the view displayed currently in the calendar interface into another view according to the interface switching instruction includes detecting the distance between two corresponding touch points of the interface switching instruction on the display unit; and correspondingly reducing the currently displayed view according to the distance changes until the currently displayed view is switched into another view.

Alternatively, correspondingly reducing the currently displayed view according to the distance changes until the currently displayed view is switched into another view includes: switching the currently displayed view into another view when the distance is smaller a first preset threshold in the case that the received interface switching instruction is a pinch-in reduction instruction; and switching the currently displayed view into another view when the distance is greater than a second preset threshold in the case that the received interface switching instruction is a pinch-out enlargement instruction.

Alternatively, in the case that the received interface switching instruction is a pinch-in reduction instruction, the corresponding reduction is in direct proportion to the reduction of the distance; and in the case that the received interface switching instruction is a pinch-out enlargement instruction, the corresponding reduction is in inverse proportion to the enlargement of the distance.

Alternatively, the interface switching instruction is replaced by a click instruction, a knock instruction, a long press instruction or a slide instruction.

The embodiments of this disclosure also disclose an electronic device including a display unit, which includes one or more processors; a memory; and one or more programs stored in the memory, and when executed by the one or more processors, performing the following steps: judging whether a current interactive graphic interface displayed by the display unit is a calendar interface or not; if the current interactive graphic interface is the calendar interface, then detecting whether an interface switching instruction is received or not in the calendar interface, where the interface switching instruction includes a pinch-in reduction instruction or a pinch-out enlargement instruction, the calendar interface only displays one view during a non-switching period, and the views include a year view and a month view; and switching the view displayed currently in the calendar interface into another view according to the interface switching instruction.

About the electronic device, where, switching the view displayed currently in the calendar interface into another view according to the interface switching instruction includes the following steps: in the case that the view displayed currently in the calendar interface is a month view, switching the month view into a year view when the pinch-in reduction instruction or the pinch-out enlargement instruction is received; or in the case that the view displayed currently in the calendar interface is a year view, switching the year view into a month view when the pinch-out enlargement instruction or the pinch-in reduction instruction is received.

About the electronic device, where, switching the view displayed currently in the calendar interface into another view according to the interface switching instruction includes the following steps: detecting the distance between two corresponding touch points of the interface switching instruction on the display unit; and correspondingly reducing the currently displayed view according to the distance changes until the currently displayed view is switched into another view.

About the electronic device, where, correspondingly reducing the currently displayed view according to the distance changes until the currently displayed view is switched into another view includes the following steps: switching the currently displayed view into another view when the distance is smaller than a first preset threshold in the case that the received interface switching instruction is a pinch-in reduction instruction; and switching the currently displayed view into another view when the distance is greater than a second preset threshold in the case that the received interface switching instruction is a pinch-out enlargement instruction.

About the electronic device, where, in the case that the received interface switching instruction is a pinch-in reduction instruction, the corresponding reduction is in direct proportion to the reduction of the distance; and in the case that the received interface switching instruction is a pinch-out enlargement instruction, the corresponding reduction is in inverse proportion to the enlargement of the distance.

About the electronic device, where, the interface switching instruction is replaced by a click instruction, a knock instruction, a long press instruction or a slide instruction.

The third objective of the embodiments of this disclosure is to provide a non-volatile computer storage medium storing computer executable instructions that, when executed by the electronic device, enable the electronic device to: judge whether a current interactive graphic interface displayed by the display unit is a calendar interface or not; if the current interactive graphic interface is the calendar interface, detect whether an interface switching instruction is received or not in the calendar interface, where the interface switching instruction includes a pinch-in reduction instruction or a pinch-out enlargement instruction, the calendar interface only displays one view during a non-switching period, and the views include a year view and a month view; and switch the view displayed currently in the calendar interface into another view according to the interface switching instruction.

About the non-volatile computer storage medium, where, switching the view displayed currently in the calendar interface into another view according to the interface switching instruction includes: in the case that the view displayed currently in the calendar interface is a month view, switching the month view into a year view when the pinch-in reduction instruction or the pinch-out enlargement instruction is received; or in the case that the view displayed currently in the calendar interface is a year view, switching the year view into a month view when the pinch-out enlargement instruction or the pinch-in reduction instruction is received.

About the non-volatile computer storage medium, switching the view displayed currently in the calendar interface into another view according to the interface switching instruction includes: detecting the distance between two corresponding touch points of the interface switching instruction on the display unit; and correspondingly reducing the currently displayed view according to the distance changes until the currently displayed view is switched into another view.

About the non-volatile computer storage medium, correspondingly reducing the currently displayed view according to the distance changes until the currently displayed view is switched into another view includes: in the case that the received interface switching instruction is a pinch-in reduction instruction, and when the distance is smaller than a first preset threshold, switching the currently displayed view into another view; and in the case that the received interface switching instruction is a pinch-out enlargement instruction, and when the distance is greater than a second preset threshold, switching the currently displayed view into another view.

About the non-volatile computer storage medium, in the case that the received interface switching instruction is a pinch-in reduction instruction, the corresponding reduction is in direct proportion to the reduction of the distance; and in the case that the received interface switching instruction is a pinch-out enlargement instruction, the corresponding reduction is in inverse proportion to the enlargement of the distance.

About the non-volatile computer storage medium, the interface switching instruction is replaced by a click instruction, a knock instruction, a long press instruction or a slide instruction.

This disclosure judges whether a current interactive graphic interface displayed by a display unit of the electronic device is a calendar interface or not; if the current interactive graphic interface is the calendar interface, then detects whether an interface switching instruction is received or not in the calendar interface, where the interface switching instruction includes a pinch-in reduction instruction or a pinch-out enlargement instruction, the calendar interfaces only displays one view during a non-switching period, and the views include a year view and a month view; and switches the view displayed currently in the calendar interface into another view according to the interface switching instruction. Because the mode of switching between the year view and the month view may be realized through various interface switching instructions, the problem that the mode of switching between the year view and the month view is relatively single in the prior art is solved, and then the diversity of the mode of switching between the year view and the month view is increased. In addition, the area for receiving the interface switching instruction is the whole area of the display unit of the electronic device, and the receiving area is relatively large, thereby solving the problem that the page switching accuracy is relatively low in the prior art, and improving the switching accuracy.

### BRIEF DESCRIPTION OF DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 is a flow diagram of a page switching method according to an embodiment of this disclosure;

FIG. 2 is a schematic diagram of a month view displayed by a display unit of an electronic device;

FIG. 3 is a schematic diagram of a year view displayed by the display unit of the electronic device;

FIG. 4 is a general schematic diagram of switching between the month view and the year view according to an embodiment of this disclosure;

FIG. 5 is a schematic diagram of a page in a process of switching the month view into the year view according to an embodiment of this disclosure;

FIG. 6 is a structural block diagram of a page switching electronic device according to an embodiment of this disclosure;

FIG. 7 is a structural block diagram of a switching module according to an embodiment of this disclosure;

FIG. 8 is another structural block diagram of a switching module according to an embodiment of this disclosure;

FIG. 9 is a structural block diagram of a third switching unit according to an embodiment of this disclosure;

FIG. 10 is a schematic diagram of a hardware structure of an electronic device provided by the embodiments of this disclosure.

### DETAILED DESCRIPTION

To make the objectives, the technical scheme and the advantages of the embodiments of this disclosure clearer, the technical scheme of this disclosure will be clearly and completely described hereinafter through implementation with reference to the accompanying drawings in the embodiments of this disclosure. Apparently, the embodiments described below are part, instead of all, of the embodiments of this disclosure.

### Embodiment 1

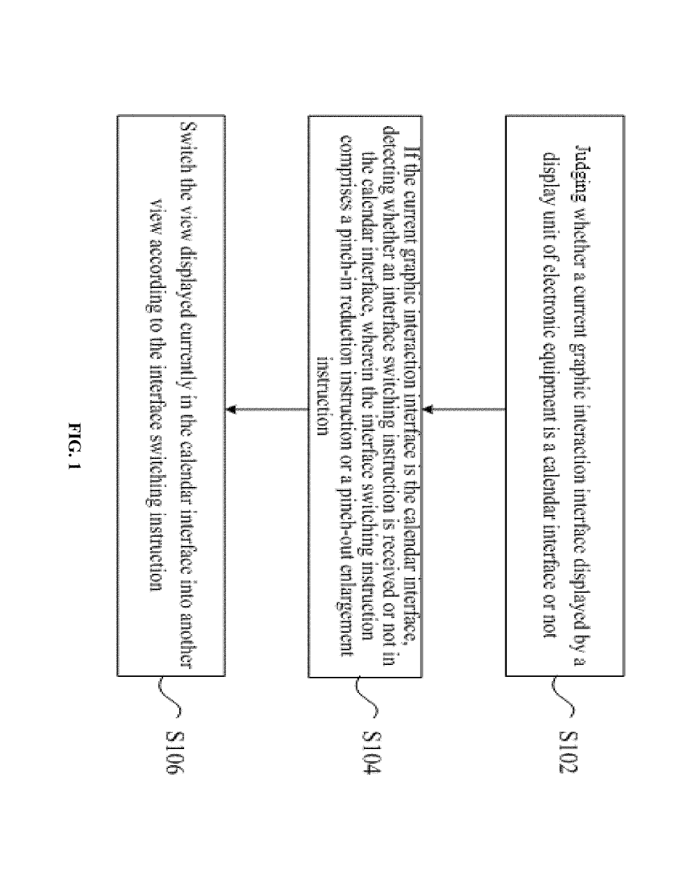

A page switching method applied to an electronic device is provided in the present embodiment, FIG. 1 is a flow diagram of the page switching method according to the embodiment of this disclosure, and as shown in FIG. 1, the process includes the following steps:

Step S102: judging whether a current interactive graphic interface displayed by a display unit of the electronic device is a calendar interface or not;

Step S104: if the current interactive graphic interface is the calendar interface, then detecting whether an interface switching instruction is received or not in the calendar interface, where the interface switching instruction includes a pinch-in reduction instruction or a pinch-out enlargement instruction, the calendar interface only displays one view during a non-switching period, and the views include a year view and a month view; and

Step S106: switching the view displayed currently in the calendar interface into another view according to the interface switching instruction.

Where, the month view displays time information of a specified month in the display unit, and the year view displays time information of a specified year in the display unit.

By the abovementioned steps, the interface switching instruction is detected in a calendar interface displayed in the electronic device, and the year view displayed in the calendar interface is switched into the month view or the month view is switched into the year view according to the interface switching instruction. As the mode of switching between the year view and the month view may be realized through various interface switching instructions, the problem that the mode of switching between the year view and the month view is relatively single in the prior art is solved, and then the diversity of the manner of switching between the year view and the month view is increased; and in addition, the area for receiving the interface switching instruction is the whole area of the display unit of the electronic device, and the receiving area is relatively large, so that the problem that the page switching accuracy is relatively low in the prior art is solved, and the switching accuracy is improved.

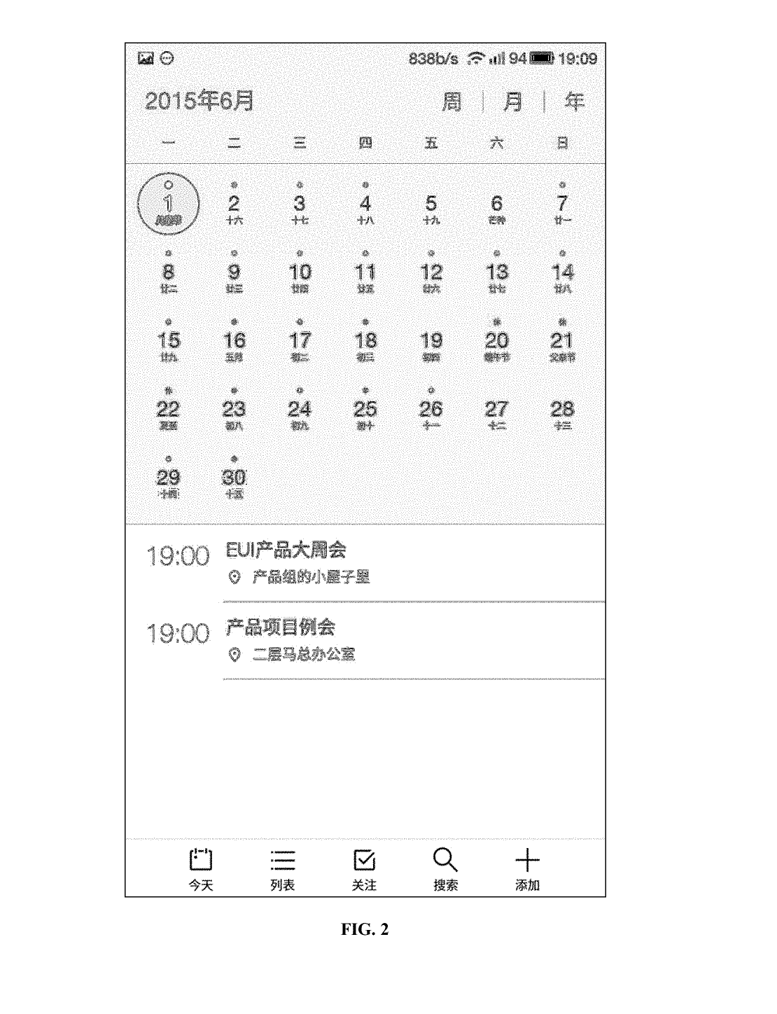

A schematic diagram of the month view displayed by the display unit of the electronic device is shown in FIG. 2, and a schematic diagram of the year view displayed by the display unit of the electronic device is shown in FIG. 3.

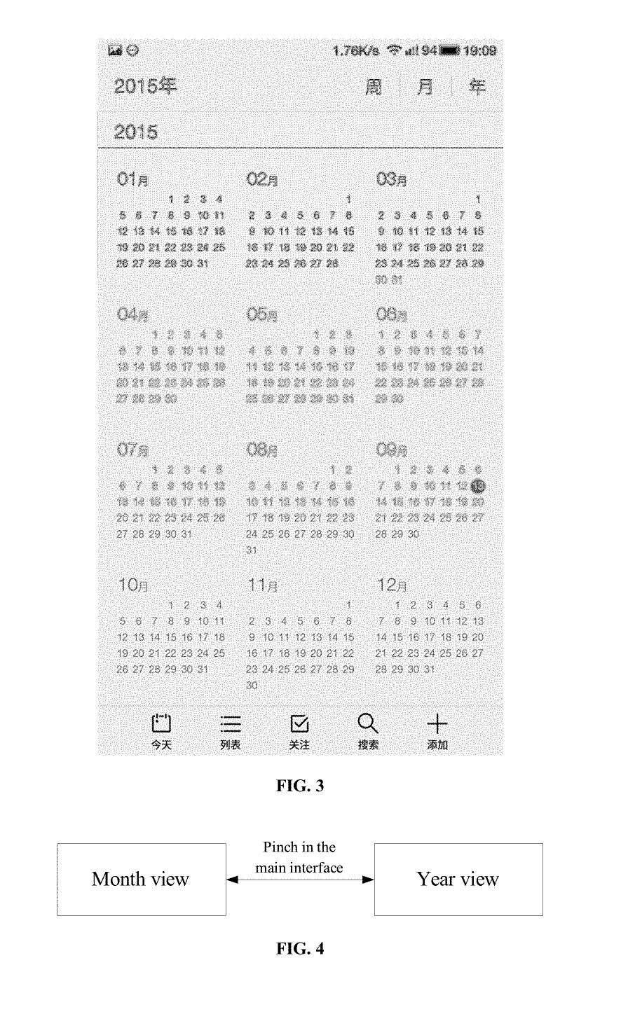

The above step S106 relates to switching the view displayed currently in the calendar interface into another view according to the interface switching instruction, and in an alternative embodiment, in the case that the view displayed currently in the calendar interface is a month view, the month view is switched into a year view when the pinch-in reduction instruction or the pinch-out enlargement instruction is received. In another alternative embodiment, in the case that the view displayed currently in the calendar interface is a year view, the year view is switched into a month view when the pinch-out enlargement instruction or the pinch-in reduction instruction is received. As the area for receiving the pinch-in reduction instruction or the pinch-out enlargement instruction is the whole area of the display unit of the electronic device, and is relatively large, the accuracy of switching between the year view and the month view is improved. FIG. 4 is a schematic diagram of switching between the month view and the year view according to the embodiments of this disclosure, and the mutual switching between the month view and the year view can be achieved through pinch operations (pinch-in reduction or pinch-out enlargement operations).

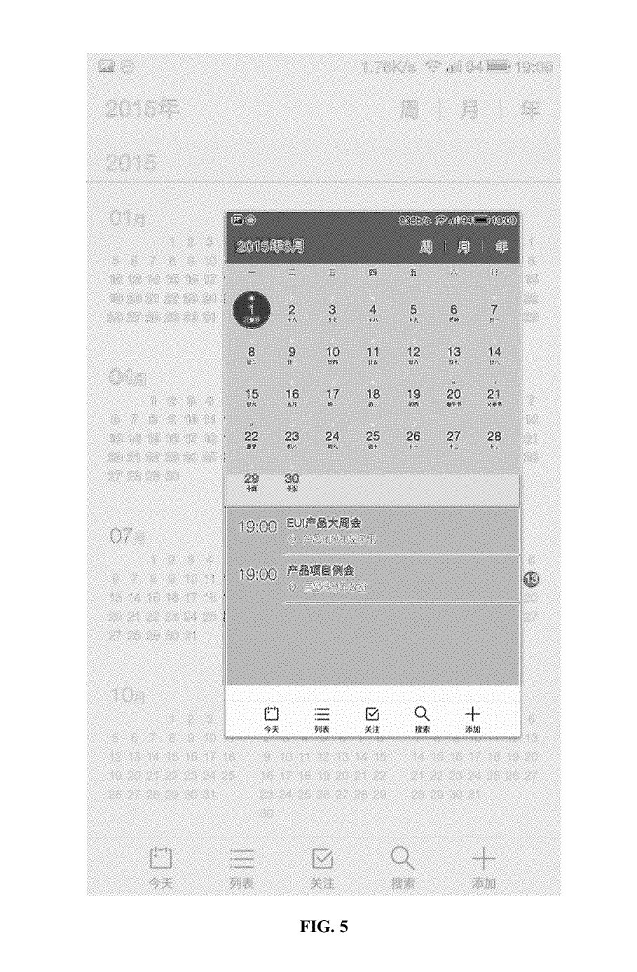

The abovementioned steps relate to achieving the mutual switching between the year month and the month view through pinch operations; in one alternative embodiment, the distance between two corresponding touch points of the interface switching instruction on the display unit is detected at first, and then the currently displayed view is correspondingly reduced according to the distance changes until the currently displayed view is switched into another view. With the distance changes between the two corresponding touch points of the interface switching instruction on the display unit, the view currently displayed by the display unit is gradually reduced, and another view is displayed on the display unit as a background at the same time until the currently displayed view is switched into the another view. As shown in FIG. 5, in the case that the month view is reduced to a certain degree, the month view is switched into the year view.

In one alternative embodiment, in the case that the received interface switching instruction is a pinch-in reduction instruction, when the abovementioned distance is smaller than a first preset threshold, the currently displayed view is switched into another view. For example, in the case that the received interface switching instruction is a pinch-in reduction instruction, and when the abovementioned distance is smaller than the first preset threshold, the currently displayed month view is switched into the year view. In another alternative embodiment, in the case that the received interface switching instruction is a pinch-out enlargement instruction, and when the abovementioned distance is greater than a second preset threshold, the currently displayed view is switched into another view. For example, in the case that the received interface switching instruction is a pinch-out enlargement instruction, and when the abovementioned distance is greater than the second preset threshold, the currently displayed year view is switched into the month view.

The abovementioned steps relate to correspondingly reducing the currently displayed view according to the distance between two corresponding touch points of the interface switching instruction on the display unit until the currently displayed view is switched into another view. In the process that the currently displayed view is reduced with the distance, in one alternative embodiment, in the case that the received interface switching instruction is a pinch-in reduction instruction, the corresponding reduction is in direct proportion to the reduction of the distance. In another alternative embodiment, in the case that the received interface switching instruction is a pinch-out enlargement instruction, the corresponding reduction is in inverse proportion to the enlargement of the distance.

The abovementioned interface switching instruction may be implemented in various ways, and is illustrated hereinafter. In one alternative embodiment, the interface switching instruction may be a pinch-in reduction instruction (pinch-in), a pinch-out enlargement instruction (pinch-out), a click instruction, a knock instruction, a long press instruction or a slide instruction. Any one of the abovementioned interface switching instruction can realize the switching between the month view and the year view of the electronic device, and then the diversity of the mode of switching between the year view and the month view is increased.

### Embodiment 2

The present embodiment also provides a page switching device applied to an electronic device, where the page switching device is for realizing the abovementioned embodiments and preferred implementation modes, some of which have been described and will no longer be repeated herein. The term “module” as used below may realize a combination of software or hardware of preset functions. Although the devices described in the following embodiments are preferably realized by software, but hardware or the combination of software and hardware may also be conceived.

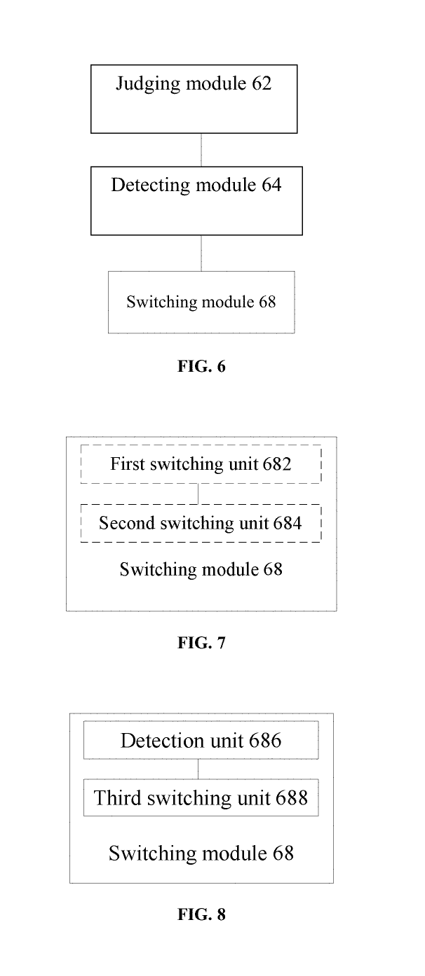

As shown in FIG. 6, the page switching device includes the following modules: a judging module 62, for judging whether a current interactive graphic interface displayed by the display unit is a calendar interface or not; a detecting module 64, for, if the current interactive graphic interface is the calendar interface, detecting whether an interface switching instruction is received or not in the calendar interface, where the interface switching instruction includes a pinch-in reduction instruction or a pinch-out enlargement instruction, the calendar interface only displays one view during a non-switching period, and the views include a year view and a month view; and a switching module 68, for switching the view displayed currently in the calendar interface into another view according to the interface switching instruction.

By using the above mentioned device, the mode of switching between the year view and the month view may be realized through various interface switching instructions. Therefore, the problem that the mode of switching between the year view and the month view is relatively single in the prior art is solved, and then the diversity of mode of switching between the year view and the month view is increased. In addition, the area for receiving the interface switching instruction is the whole area of the display unit of the electronic device, and the receiving area is relatively large, so that the problem that the page switching is less accurate in the prior art is solved, and the switching accuracy is improved.

As shown in FIG. 7, the switching module 68 includes the following units: a first switching unit 682, for, in the case that the view displayed currently in the calendar interface is a month view, switching the month view into a year view when the pinch-in reduction instruction or the pinch-out enlargement instruction is received; or a second switching unit 684, for, in the case that the view displayed currently in the calendar interface is a year view, switching the year view into a month view when the pinch-out enlargement instruction or the pinch-in reduction instruction is received.

As shown in FIG. 8, the switching module 68 also includes the following units: a detecting unit 686, for detecting the distance between two corresponding touch points of the interface switching instruction on the display unit; and a third switching unit 688, for correspondingly reducing the currently displayed view according to the distance changes until the currently displayed view is switched into another view.

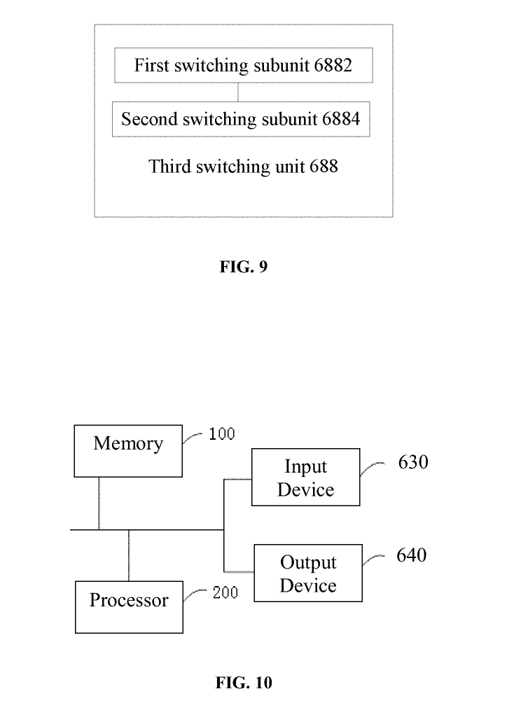

As shown in FIG. 9, the third switching unit 688 includes the following subunits: a first switching subunit 6882, for, in the case that the received interface switching instruction is a pinch-in reduction instruction, when the distance is smaller a first preset threshold, switching the currently displayed view into another view; and a second switching subunit 6884, for, in the case that the received interface switching instruction is a pinch-out enlargement instruction, when the distance is greater than a second preset threshold, switching the currently displayed view into another view.

Alternatively, the first switching subunit 6882 is also used when the received interface switching instruction is a pinch-in reduction instruction, so that the corresponding reduction is in direct proportion to the reduction of the distance; and the second switching subunit 6884 is also used when the received interface switching instruction is a pinch-out enlargement instruction, so that the corresponding reduction is in inverse proportion to the enlargement of the distance.

Alternatively, the interface switching instruction is replaced by a click instruction, a knock instruction, a long press instruction or a slide instruction.

### Embodiment 3

FIG. 10 is a schematic diagram of a hardware structure of an electronic device for executing the page switching method provided by the embodiment of this disclosure, and as shown in FIG. 10, the device includes one or more processors 200 and a memory 100, and one processor 200 is taken as an example in FIG. 10; and the device for executing the page switching method may also include: an input device 630 and an output device 640.

The processor 200, the memory 100, the input device 630 and the output device 640 may be connected with a bus or in other ways, and bus connection is taken as an example in FIG. 10

The memory 100, as a non-volatile computer readable storage medium, may be used for storing non-volatile software programs, non-volatile computer executable programs and modules, for example, program instructions/modules (e.g., a judging module 62, a detecting module 64 and a switching module 68 shown in FIG. 6) corresponding to the page switching method in the embodiments of this disclosure. The processor 200 runs the non-volatile software programs, instructions and modules stored in the memory 100, so as to execute various functional applications and data processing of a server, thereby implementing the page switching method in the abovementioned embodiments of the method.

The memory 100 may include a program storage area and a data storage area, where the program storage area may store an operating system and applications for at least one functions; and the data storage area may store data and the like created according to the use of the page switching device. Moreover, the memory 100 may include a high-speed random access memory, and may also include a non-volatile memory, for example, at least one disk storage device, a flash memory, or other non-volatile solid storage devices. In some embodiments, the memory 100 alternatively includes memories that are set remotely relative to the processor 200, and these remote memories may be connected to the page switching device through a network. An example of the network includes, but is not limited to, internet, intranet, LAN, mobile communication network and the combinations thereof.

The input device 630 may receive input digit or character information and generate a key signal input related to the user configuration and function control of the page switching device. The output device 640 may include display devices such as a display screen.

The one or more modules are stored in the memory 100, and when executed by the one or more processors 200, perform the page switching method in any one of the abovementioned embodiments of the method.

The abovementioned product can perform the method provided by the embodiments of this disclosure and have corresponding functional modules for executing the method and beneficial effects. For more technical details of the present embodiment, please refer to the method provided by the embodiments of this disclosure.

The electronic device of the embodiments of this disclosure exists in many forms, including but not limited to the following devices:

(1) Mobile communication devices: the characteristic of such devices is that they have a mobile communication function with a main goal of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, intelligent toys, and portable vehicle navigation devices.

(4) Servers: devices providing computing services. The structure of a server includes a processor, a hard disk, an internal memory, a system bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned device embodiments are only illustrative, where the units described as separate parts may be or may not be physically separated, the components shown as units may be or may not be physical units, i.e. may be located in one place, or may be distributed at multiple network units. According to actual needs, part of or all of the modules therein may be selected to realize the objectives of the technical scheme of the embodiment.

By abovementioned descriptions of the implementations, those skilled in the art can clearly understand that the various implementations may be implemented by software and a general hardware platform, and of course, may also be implemented by hardware. Based on such understanding, the abovementioned technical scheme in essence, or the part thereof making a contribution to related technology, may be embodied in the form of a software product, and such a computer software product may be stored in a computer readable storage medium such as an ROM/RAM, a magnetic disk or an optical disk, etc., and may include a number of instructions to enable a computer device (which may be a personal computer, a server, or a network device, etc.) to execute the methods described in the various embodiments or in some parts thereof.

### Embodiment 4

The embodiments of this disclosure provide a non-volatile computer storage medium storing computer executable instructions that, when executed by the electronic device, enable the electronic device to: judge whether a current interactive graphic interface displayed by the display unit is a calendar interface or not; if the current interactive graphic interface is the calendar interface, detect whether an interface switching instruction is received or not in the calendar interface, where the interface switching instruction includes a pinch-in reduction instruction or a pinch-out enlargement instruction, the calendar interface only displays one view during a non-switching period, and the views include a year view and a month view; and switch the view displayed currently in the calendar interface into another view according to the interface switching instruction.

As a preferred implementation, switching the view displayed currently in the calendar interface into another view according to the interface switching instruction includes: in the case that the view displayed currently in the calendar interface is a month view, switching the month view into a year view when the pinch-in reduction instruction or the pinch-out enlargement instruction is received; or in the case that the view displayed currently in the calendar interface is a year view, switching the year view into a month view when the pinch-out enlargement instruction or the pinch-in reduction instruction is received.

As a preferred implementation, switching the view displayed currently in the calendar interface into another view according to the interface switching instruction includes: detecting the distance between two corresponding touch points of the interface switching instruction on the display unit; and correspondingly reducing the currently displayed view according to the distance changes until the currently displayed view is switched into another view.

As a preferred implementation, correspondingly reducing the currently displayed view according to the distance changes until the currently displayed view is switched into another view includes: in the case that the received interface switching instruction is a pinch-in reduction instruction, switching the currently displayed view into another view when the distance is smaller than a first preset threshold; and in the case that the received interface switching instruction is a pinch-out enlargement instruction, switching the currently displayed view into another view when the distance is greater than a second preset threshold.

As a preferred implementation, in the case that the received interface switching instruction is a pinch-in reduction instruction, the corresponding reduction is in direct proportion to the reduction of the distance; and in the case that the received interface switching instruction is a pinch-out enlargement instruction, the corresponding reduction is in inverse proportion to the enlargement of the distance.

As a preferred implementation, the interface switching instruction is replaced by a click instruction, a knock instruction, a long press instruction or a slide instruction.

Finally, it should be noted that: the abovementioned embodiments are merely illustrated for describing rather than limiting the technical scheme of this disclosure; although detailed description of this disclosure is given with reference to the abovementioned embodiments, those skilled in the art should understand that they still can modify the technical scheme recorded in the abovementioned various embodiments or replace part of the technical features therein with equivalents; and these modifications or replacements would not cause the essence of the corresponding technical scheme to depart from the spirit and scope of the technical scheme of the various embodiments of this disclosure.

What is claimed is:

1. A page switching method applied to an electronic device, comprising a display unit, characterized in comprising:
judging whether a current interactive graphic interface displayed by the display unit is a calendar interface or not;
if the current interactive graphic interface is the calendar interface, detecting whether an interface switching instruction is received or not in the calendar interface, wherein the interface switching instruction comprises a pinch-in reduction instruction or a pinch-out enlargement instruction, the calendar interface only displays one view during a non-switching period, and the views comprise a year view and a month view; and
switching the view displayed currently in the calendar interface into another view according to the interface switching instruction.

2. The method according to claim 1, characterized in that, switching the view displayed currently in the calendar interface into another view according to the interface switching instruction comprises:
in the case that the view displayed currently in the calendar interface is a month view, switching the month view into a year view when the pinch-in reduction instruction or the pinch-out enlargement instruction is received; or
in the case that the view displayed currently in the calendar interface is a year view, switching the year view into a month view when the pinch-out enlargement instruction or the pinch-in reduction instruction is received.

3. The method according to claim 1, characterized in that, switching the view displayed currently in the calendar interface into another view according to the interface switching instruction comprises:
detecting the distance between two corresponding touch points of the interface switching instruction on the display unit; and
correspondingly reducing the currently displayed view according to the distance changes until the currently displayed view is switched into another view.

4. The method according to claim 3, characterized in that, correspondingly reducing the currently displayed view according to the distance changes until the currently displayed view is switched into another view comprises:
in the case that the received interface switching instruction is a pinch-in reduction instruction, switching the currently displayed view into another view when the distance is smaller a first preset threshold; and
in the case that the received interface switching instruction is a pinch-out enlargement instruction, switching the currently displayed view into another view when the distance is greater than a second preset threshold.

5. The method according to claim 3, characterized in that, in the case that the received interface switching instruction is a pinch-in reduction instruction, the corresponding reduction is in direct proportion to the reduction of the distance; and
in the case that the received interface switching instruction is a pinch-out enlargement instruction, the corresponding reduction is in inverse proportion to the enlargement of the distance.

6. The method according to claim 1, characterized in that, the interface switching instruction is replaced by a click instruction, a knock instruction, a long press instruction or a slide instruction.

7. An electronic device, characterized in comprising at least one processor, and a memory in communication connection with the at least one processor, wherein the memory stores instructions that can be executed by the at least one processor, and the instructions are executed by the at least one processor to enable the at least one processor to:
judge whether a current interactive graphic interface displayed by the display unit is a calendar interface or not;
if the current interactive graphic interface is the calendar interface, detect whether an interface switching instruction is received or not in the calendar interface, wherein the interface switching instruction comprises a pinch-in reduction instruction or a pinch-out enlargement instruction, the calendar interface only displays one view during a non-switching period, and the views comprise a year view and a month view; and
switch the view displayed currently in the calendar interface into another view according to the interface switching instruction.

8. The electronic device according to claim 7, characterized in that, switching the view displayed currently in the calendar interface into another view according to the interface switching instruction comprises:
in the case that the view displayed currently in the calendar interface is a month view, switching the month view into a year view when the pinch-in reduction instruction or the pinch-out enlargement instruction is received; or
in the case that the view displayed currently in the calendar interface is a year view, switching the year view into a month view when the pinch-out enlargement instruction or the pinch-in reduction instruction is received.

9. The electronic device according to claim 7, characterized in that, switching the view displayed currently in the calendar interface into another view according to the interface switching instruction comprises:
detecting the distance between two corresponding touch points of the interface switching instruction on the display unit; and
correspondingly reducing the currently displayed view according to the distance changes until the currently displayed view is switched into another view.

10. The electronic device according to claim 9, characterized in that, correspondingly reducing the currently displayed view according to the distance changes until the currently displayed view is switched into another view comprises:
in the case that the received interface switching instruction is a pinch-in reduction instruction, switching the currently displayed view into another view when the distance is smaller than a first preset threshold; and
in the case that the received interface switching instruction is a pinch-out enlargement instruction, switching the currently displayed view into another view when the distance is greater than a second preset threshold.

11. The electronic device according to claim 9, characterized in that, in the case that the received interface switching instruction is a pinch-in reduction instruction, the corresponding reduction is in direct proportion to the reduction of the distance; and
in the case that the received interface switching instruction is a pinch-out enlargement instruction, the corresponding reduction is in inverse proportion to the enlargement of the distance.

12. The electronic device according to claim 7, characterized in that, the interface switching instruction is replaced by a click instruction, a knock instruction, a long press instruction or a slide instruction.

13. A non-volatile computer storage medium storing computer executable instructions, characterized in that, the computer executable instructions, when executed by the electronic device, enable the electronic device to:
judge whether a current interactive graphic interface displayed by the display unit is a calendar interface or not;
if the current interactive graphic interface is the calendar interface, detect whether an interface switching instruction is received or not in the calendar interface, wherein the interface switching instruction comprises a pinch-in reduction instruction or a pinch-out enlargement instruction, the calendar interface only displays one view during a non-switching period, and the views comprise a year view and a month view; and
switch the view displayed currently in the calendar interface into another view according to the interface switching instruction.

14. The non-volatile computer storage medium according to claim 13, characterized in that, switching the view displayed currently in the calendar interface into another view according to the interface switching instruction comprises:
in the case that the view displayed currently in the calendar interface is a month view, switching the month view into a year view when the pinch-in reduction instruction or the pinch-out enlargement instruction is received; or
in the case that the view displayed currently in the calendar interface is a year view, switching the year view into a month view when the pinch-out enlargement instruction or the pinch-in reduction instruction is received.

15. The non-volatile computer storage medium according to claim 13, characterized in that, switching the view displayed currently in the calendar interface into another view according to the interface switching instruction comprises:
detecting the distance between two corresponding touch points of the interface switching instruction on the display unit; and
correspondingly reducing the currently displayed view according to the distance changes until the currently displayed view is switched into another view.

16. The non-volatile computer storage medium according to claim 15, characterized in that, correspondingly reducing the currently displayed view according to the distance changes until the currently displayed view is switched into another view comprises:
in the case that the received interface switching instruction is a pinch-in reduction instruction, switching the currently displayed view into another view when the distance is smaller than a first preset threshold; and
in the case that the received interface switching instruction is a pinch-out enlargement instruction, switching the currently displayed view into another view when the distance is greater than a second preset threshold.

17. The non-volatile computer storage medium according to claim 15, characterized in that, in the case that the received interface switching instruction is a pinch-in reduction instruction, the corresponding reduction is in direct proportion to the reduction of the distance; and
in the case that the received interface switching instruction is a pinch-out enlargement instruction, the corresponding reduction is in inverse proportion to the enlargement of the distance.

18. The non-volatile computer storage medium according to claim 13, characterized in that, the interface switching instruction is replaced by a click instruction, a knock instruction, a long press instruction or a slide instruction.
